(19) United States
(12) Patent Application Publication
(10) Pub. No.: US 2012/0003139 A1
(43) Pub. Date: Jan. 5, 2012

(54) METHOD FOR MANUFACTURING POWER STORAGE DEVICE

(75) Inventors: Takahiro KAWAKAMI, Atsugi (JP); Takuya MIWA, Atsugi, (JP)

(73) Assignee: SEMICONDUCTOR ENERGY LABORATORY CO., LTD., Atsugi-shi (JP)

(21) Appl. No.: 13/153,505

(22) Filed: Jun. 6, 2011

(30) Foreign Application Priority Data
Jun. 30, 2010 (JP) 2010-148970

(51) Int. Cl. C01B 25/45; C01B 33/32

(52) U.S. Cl. 423/306; 423/332

(57) ABSTRACT

It is an object to provide a material for an electrode with improved electron conductivity and a power storage device using the material for an electrode. In a process for manufacturing a material for an electrode including a lithium phosphate compound represented by a general formula LiMPO₄ having an olivine structure or a lithium silicate compound represented by a general formula Li₂MSiO₄ having an olivine structure, a metal element having a valence different from that of a metal element represented by M is added. The metal element having a different valence serves as a carrier generation source in the material for an electrode, whereby the electron conductivity of the material for an electrode is improved. By using the material for an electrode with improved electron conductivity as a positive electrode active material, a power storage device with larger discharge capacity is provided.

### BACKGROUND OF THE INVENTION

1. Field of the Invention

An embodiment of the present invention relates to a power storage device and a method for manufacturing the power storage device.

2. Description of the Related Art

The field of portable electronic devices such as a personal computer and a mobile phone has progressed significantly. A portable electronic device needs a chargeable power storage device having high energy density, which is small, lightweight, and reliable. As such a power storage device, for example, a lithium-ion secondary battery is known. In addition, development of an electrically propelled vehicle on which a lithium-ion secondary battery is mounted has also progressed rapidly owing to growing awareness of environmental problems and energy problems.

As a positive electrode active material in a lithium-ion secondary battery, a phosphate compound having an olivine structure and containing lithium (Li) and iron (Fe), manganese (Mn), cobalt (Co), or nickel (Ni), such as lithium iron phosphate (LiFePO₄), lithium manganese phosphate (LiMnPO₄), lithium cobalt phosphate (LiCoPO₄), or lithium nickel phosphate (LiNiPO₄), is known for example (see Patent Document 1, Non-Patent Document 1, and Non-Patent Document 2).

In addition, it has been proposed to use a silicate-based compound that has an olivine structure like the above-mentioned phosphate compound as a positive electrode active material of a lithium-ion secondary battery (e.g., Patent Document 2).

### REFERENCE

### Patent Document

[Patent Document 1] Japanese Published Patent Application No. H11-25983
[Patent Document 2] Japanese Published Patent Application No. 2007-335325

### Non-Patent Document

[Non-Patent Document 1] Byoungwoo Kang, Gerbrand Ceder, “Nature”, 2009, Vol. 458 (12), pp. 190-193
[Non-Patent Document 2] F. Zhou et al., “Electrochemistry Communications”, 2004, Vol. 6, pp. 1144-1148

### SUMMARY OF THE INVENTION

However, a phosphate compound having an olivine structure or a silicate compound having an olivine structure has low bulk electron conductivity (electron conductivity of the compound itself); thus, it is difficult for such a compound to obtain sufficient characteristics as a material for an electrode alone.

In view of the above problem, it is an object of an embodiment of the disclosed invention to provide a material for an electrode with improved electron conductivity and a power storage device using the material for an electrode.

In addition, it is an object of an embodiment of the disclosed invention to provide a material for an electrode with which a power storage device can have large discharge capacity and a power storage device using the material for an electrode.

In accordance with an embodiment of the present invention, in a process for manufacturing a material for an electrode including a lithium phosphate compound represented by a general formula LiMPO₄ having an olivine structure or a lithium silicate compound represented by a general formula Li₂MSiO₄ having an olivine structure, a metal element having a valence different from that of a metal element represented by M is added. The metal element having a different valence serves as a carrier generation source in the material for an electrode, whereby the electron conductivity of the manufactured material for an electrode is improved.

Specifically, an embodiment of the present invention is a method for manufacturing a power storage device including the steps of: mixing a compound containing lithium, a compound containing a first metal element selected from the group consisting of manganese, iron, cobalt, and nickel, a compound containing phosphorus, and a compound containing a second metal element having a valence different from that of the first metal element to form a mixture material; and baking the mixture material to form a lithium phosphate compound containing the first metal element.

Another embodiment of the present invention is a method for manufacturing a power storage device, including the steps of: mixing a compound containing lithium, a compound containing a first metal element selected from the group consisting of manganese, iron, cobalt, and nickel, a compound containing silicon, and a compound containing a second metal element having a valence different from that of the first metal element to form a mixture material; and baking the mixture material to form a lithium silicate compound containing the first metal element.

In the method for manufacturing a power storage device, the baking of the mixture material may include first baking in which heat treatment is performed at a temperature of greater than or equal to 300° C. and less than or equal to 400° C. and second baking in which heat treatment is performed at a temperature of greater than or equal to 500° C. and less than or equal to 800° C.

In addition, in the method for manufacturing a power storage device, a metal element whose valence is 1 or 2 larger than that of the first metal element or a metal element whose valence is 1 or 2 smaller than that of the first metal element is preferably used as the second metal element.

In addition, in the method for manufacturing a power storage device, Fe₂O₃, Ti₂O₃, Cu₂O, or SiO₂ is preferably used as the compound containing the second metal element.

In addition, in the method for manufacturing a power storage device, the mixture material preferably contains the second metal element at greater than or equal to 1 mol % and less than or equal to 10 mol % with respect to the first metal element.

In accordance with an embodiment of the disclosed invention, a material for an electrode with improved electron conductivity can be obtained. In accordance with another embodiment of the disclosed invention, a power storage device with large discharge capacity can be obtained.

### BRIEF DESCRIPTION OF THE DRAWINGS

FIG. 1 illustrates an embodiment of a power storage device.

FIGS. 2A and 2B each illustrate an application example of a power storage device.

FIGS. 3A and 3B each illustrate an application example of a power storage device.

FIG. 4 shows the characteristics of a material for an electrode formed in Example.

FIG. 5 shows the characteristics of a power storage device formed in Example.

### DETAILED DESCRIPTION OF THE INVENTION

Hereinafter, embodiments and an example of the present invention are described with reference to the drawings. However, the present invention is not limited to the following description. It is readily appreciated by those skilled in the art that modes and details of the present invention can be changed in various ways without departing from the spirit and the scope thereof Therefore, the present invention should not be construed as being limited to the following description of the embodiments and the example. Note that reference numerals denoting the same portions are commonly used in different drawings in describing the structure of the present invention.

Note that the size, the thickness of a layer, and a region of each structure illustrated in the drawings and the like in the embodiments are exaggerated for simplicity in some cases. Therefore, embodiments of the present invention are not limited to such scales.

Note that terms with ordinal numbers such as “first”, “second”, and “third” in this specification are used in order to identify components, and the terms do not limit the components numerically.

### Embodiment 1

In this embodiment, an example of a method for manufacturing a material for an electrode will be described. Specifically, in this embodiment, an example of a method for manufacturing a material for an electrode including a lithium phosphate compound represented by a general formula LiMPO₄ or a lithium silicate compound represented by a general formula Li₂MSiO₄ will be described. A method for manufacturing a material for an electrode using a solid-phase method will be described below, but this embodiment is not limited thereto, and a material for an electrode may be manufactured using a liquid-phase method.

In the above general formula, M represents one or more metal elements selected from transition metals such as manganese (Mn), iron (Fe), cobalt (Co), nickel (Ni), and the like.

### <Method for Manufacturing Lithium Phosphate Compound>

First, a compound containing lithium which supplies Li in LiMPO₄, a compound containing phosphorus which supplies P in LiMPO₄, a compound containing a first metal element which supplies M in LiMPO₄ and is selected from transition metals such as manganese, iron, cobalt, and nickel, and a compound containing a second metal element having a valence different from that of the first metal element are mixed, so that a mixture material is formed.

As the compound containing lithium, for example, lithium salt such as lithium carbonate (Li₂CO₃), lithium oxide (Li₂O), lithium sulfide (Li₂S), lithium peroxide (Li₂O₂), lithium sulfate (Li₂SO₄), lithium sulfite (Li₂SO₃), lithium thiosulfate (Li₂S₂O₃), lithium chromate (Li₂CrO₄), or lithium dichromate (Li₂Cr₂O₇) can be used.

In addition, as the compound containing the first metal element, for example, an oxide such as iron oxide (FeO), manganese oxide (MnO), cobalt oxide (CoO), or nickel oxide (NiO), an oxalate such as iron (II) oxalate dihydrate (FeC₂O₄.2H₂O), manganese (II) oxalate dihydrate (MnC₂O₄.2H₂O), cobalt (II) oxalate dihydrate (CoC₂O₄.2H₂O), or nickel (II) oxalate dihydrate (NiC₂O₄.2H₂O), a carbonate such as iron (II) carbonate (FeCO₃), manganese (II) carbonate (MnCO₃), cobalt (II) carbonate (CoCO₃), or nickel (II) carbonate (NiCO₃), or the like can be used.

In addition, as the compound containing phosphorus, for example, a phosphate such as ammonium dihydrogen phosphate (NH₄H₂PO₄) or diphosphorus pentoxide (P₂O₅) can be used.

The second metal element serves as a carrier generation source (or a carrier injection source) in the material for an electrode which is to be formed. Specifically, the second metal element contained as an impurity in the lithium phosphate compound that is the material for an electrode causes defects in the first metal element. The defects generate carriers. Accordingly, the addition of the second metal element can improve the electron conductivity of the material for an electrode (here, the lithium phosphate compound).

In order to achieve the above effect, a compound containing the second metal element having a valence different from that of the first metal element can be used for the compound to be contained in the mixture material. For example, when manganese (II) carbonate (MnCO₃) containing divalent manganese is used as the compound containing the first metal element, copper oxide (Cu₂O) containing monovalent copper, iron oxide (Fe₂O₃) containing trivalent iron, titanium oxide (Ti₂O₃) containing trivalent titanium, silicon oxide (SiO₂) containing tetravalent silicon, or the like can be used as the compound containing the second metal element. However, combination of the compound containing the first metal element and the compound containing the second metal element is not limited to the above. In addition, the compound containing the second metal element is not limited to an oxide. However, with the use of an oxide, an influence of an impurity on the lithium phosphate compound which is to be formed can be controlled to be caused by the second metal element; therefore, it is preferable to use an oxide as the compound containing the second metal element.

As the second metal element, it is preferable to select a metal element whose valence is 1 or 2 larger than that of the first metal element or a metal element whose valence is 1 or 2 smaller than that of the first metal element. When the additive amount of the second metal element is too large, a by-product could be generated in the material for an electrode which is to be formed, so that the amount of the second metal element is preferably greater than or equal to 1 mol % and less than or equal to 10 mol %, more preferably greater than or equal to 2 mol % and less than or equal to 5 mol % of the first metal element.

As a method for mixing the above compounds, for example, ball mill treatment can be used. Specifically, a solvent such as acetone that is highly volatile is added to the compounds, and the compounds are mixed by rotation at greater than or equal to 50 rpm and less than or equal to 500 rpm for greater than or equal to 30 minutes and less than or equal to 5 hours with the use of metal or ceramic balls (with a diameter φ of greater than or equal to 1 mm and less than or equal to 10 mm). With ball mill treatment, the compounds can be mixed and formed into minute particles, so that the material for an electrode (such as the lithium phosphate compound) that is to be manufactured can be minute particles. In addition, with ball mill treatment, the compounds can be uniformly mixed, and the crystallinity of the material for an electrode that is to be manufactured can be made high. Note that acetone is given as a solvent, but another solvent in which the materials are not dissolved such as ethanol or methanol can also be used.

Then, after heating the mixture material and evaporating the solvent, pressure is applied with a pellet press to form the mixture material into pellets. The pellets are subjected to first heat treatment (pre-baking). The first heat treatment may be performed at a temperature of greater than or equal to 300° C. and less than or equal to 400° C. for greater than or equal to 1 hour and less than or equal to 20 hours, preferably less than or equal to 10 hours. By performing the first heat treatment (pre-baking) at a lower temperature of less than or equal to 400° C., crystal growth can be suppressed and crystal nuclei can be formed. Therefore, the material for an electrode can be formed into minute particles.

The heat treatment is preferably performed in a hydrogen atmosphere, or an inert gas atmosphere of a rare gas (such as helium, neon, argon, or xenon) or nitrogen.

Next, the mixture material subjected to the heat treatment is ground in a mortar or the like, and mixing is performed with ball mill treatment in a manner similar to the above. Then, after heating a mixture material obtained by performing mixing again and evaporating a solvent, pressure is applied with a pellet press to form the mixture material into pellets. The pellets are subjected to second heat treatment (main-baking).

The second heat treatment may be performed at a temperature of greater than or equal to 500° C. and less than or equal to 800° C. (preferably about 600° C.) for greater than or equal to 1 hour and less than or equal to 20 hours (preferably less than or equal to 10 hours). The temperature of the second heat treatment is preferably higher than the temperature of the first heat treatment.

Through the above process, the lithium phosphate compound that can be used as the material for an electrode can be manufactured.

### <Method for Manufacturing Lithium Silicate Compound>

Next, a method for manufacturing a lithium silicate compound represented by a general formula Li₂MSiO₄ will be described.

First, a compound containing lithium which supplies Li in Li₂MSiO₄, a compound containing silicon which supplies Si in Li₂MSiO₄, a compound containing a first metal element which supplies M in Li₂MSiO₄ and is selected from transition metals such as manganese, iron, cobalt, and nickel, and a compound containing a second metal element having a valence different from that of the first metal element are mixed, so that a mixture material is formed.

As the compound containing silicon, for example, silicon oxide (such as SiO₂ or SiO), lithium silicate (Li₂SiO₃), or the like can be used.

In order to manufacture the lithium silicate compound, the compound containing silicon which supplies Si may be used instead of the compound containing phosphorus which supplies P, in the above method for manufacturing the lithium phosphate compound. Thus, the method for manufacturing the lithium phosphate compound can be referred to for other details, so that the detailed description will be omitted.

The second metal element which serves as a carrier generation source is added to the material for an electrode according to this embodiment formed through the above process, whereby the electron conductivity can be improved. Accordingly, in a power storage device formed using this material for an electrode, the discharge capacity can be improved, and the charging and discharging rate, that is, the rate characteristics can be improved.

The structures, methods, and the like described in this embodiment can be combined as appropriate with any of the structures, methods, and the like described in other embodiments.

### Embodiment 2

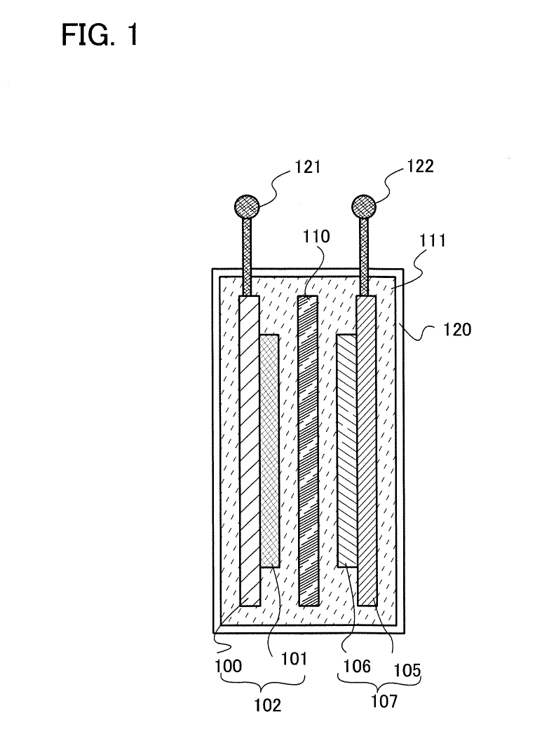

In this embodiment, a lithium-ion secondary battery in which the material for an electrode obtained through the manufacturing process in Embodiment 1 is used as a positive electrode active material will be described. The schematic structure of the lithium-ion secondary battery is illustrated in FIG. 1.

In the lithium-ion secondary battery illustrated in FIG. 1, a positive electrode 102, a negative electrode 107, and a separator 110 are provided in a housing 120 which isolates the components from the outside, and the housing 120 is filled with an electrolyte solution (an electrolyte) 111. The separator 110 is provided between the positive electrode 102 and the negative electrode 107. A first electrode 121 and a second electrode 122 are connected to a positive electrode current collector 100 and a negative electrode current collector 105, respectively, and charging and discharging are performed by the first electrode 121 and the second electrode 122. Moreover, there are certain gaps between a positive electrode active material layer 101 and the separator 110 and between a negative electrode active material layer 106 and the separator 110. However, the structure is not limited thereto; the positive electrode active material layer 101 may be in contact with the separator 110, and the negative electrode active material layer 106 may be in contact with the separator 110. In addition, the lithium-ion secondary battery may be rolled into a cylinder shape, with the separator 110 provided between the positive electrode 102 and the negative electrode 107.

The positive electrode active material layer 101 is formed over the positive electrode current collector 100. The positive electrode active material layer 101 contains the material for an electrode which is manufactured in Embodiment 1. Meanwhile, the negative electrode active material layer 106 is formed over the negative electrode current collector 105. In this specification, the positive electrode active material layer 101 and the positive electrode current collector 100 over which the positive electrode active material layer 101 is formed are collectively referred to as the positive electrode 102. In addition, the negative electrode active material layer 106 and the negative electrode current collector 105 over which the negative electrode active material layer 106 is formed are collectively referred to as the negative electrode 107.

Note that “active material” refers to a material that relates to insertion and elimination of ions which function as carriers and does not include a carbon layer including glucose, or the like. Thus, for example, the conductivity of the active material refers to the conductivity of the active material itself and does not refer to the conductivity of an active material layer including a carbon layer which is formed on a surface thereof.

As the positive electrode current collector 100, a material having high conductivity such as aluminum or stainless steel can be used. The positive electrode current collector 100 can have a foil shape, a plate shape, a net shape, or the like as appropriate.

As the positive electrode active material, the lithium phosphate compound or the lithium silicate compound described in Embodiment 1 can be used.

The lithium phosphate compound or the lithium silicate compound obtained by the second baking (main-baking) is ground again in a ball-mill machine to be formed into fine powder. A conduction auxiliary agent, a binder, and a solvent are mixed into the obtained fine powder to make it into paste.

As the conduction auxiliary agent, a material which is itself an electron conductor and does not cause chemical reaction with other materials in a battery device may be used. For example, carbon-based materials such as graphite, carbon fiber, carbon black, acetylene black, and VGCF (registered trademark); metal materials such as copper, nickel, aluminum, and silver; and powder, fiber, and the like of mixtures thereof can be given. The conduction auxiliary agent is a material that assists conduction between active materials; it is provided between active materials which are apart and makes conduction between the active materials.

The binder is exemplified by polysaccharides, thermoplastic resins, elastic polymers or the like, such as starch, polyvinyl alcohol, carboxymethyl cellulose, hydroxypropyl cellulose, regenerated cellulose, diacetyl cellulose, polyvinyl chloride, polyvinyl pyrrolidone, polytetrafluoroethylene, polyvinyliden fluoride, polyethylene, polypropylene, ethylene-propylene-diene monomer (EPDM) rubber, sulfonated EPDM rubber, styrene-butadiene rubber, butadiene rubber, fluorine rubber, polyethylene oxide or the like.

The lithium phosphate compound or the lithium silicate compound used as the material for an electrode, the conduction auxiliary agent, and the binder are mixed at 80 wt % to 96 wt %, 2 wt % to 10 wt %, and 2 wt % to 10 wt %, respectively, to be 100 wt % in total. Further, an organic solvent, the volume of which is substantially the same as that of a mixture of the material for an electrode, the conduction auxiliary agent, and the binder, is mixed to the mixture, and this mixture is processed into a slurry state. Note that an object which is obtained by processing, into a slurry state, a mixture of the material for an electrode, the conduction auxiliary agent, the binder, and the organic solvent is referred to as slurry. As the solvent, N-methyl-2-pyrrolidone, lactic acid ester, or the like can be used. The proportions of the active material, the conduction auxiliary agent, and the binder are preferably adjusted as appropriate in such a manner that, for example, when the active material and the conduction auxiliary agent have low adhesiveness at the time of film formation, the amount of binder is increased, and when the resistance of the active material is high, the amount of the conduction auxiliary agent is increased.

Here, an aluminum foil is used as the positive electrode current collector 100. The slurry is dripped thereon and is thinly spread by a casting method. Then, after the slurry is further stretched by a roller press machine and the thickness is made uniform, vacuum drying (under a pressure of less than or equal to 10 Pa) or heat drying (at a temperature of 150° C. to 280° C.) is performed, so that the positive electrode active material layer 101 is formed over the positive electrode current collector 100. As the thickness of the positive electrode active material layer 101, a desired thickness is selected from the range of 20 μm to 100 μm. It is preferable to adjust the thickness of the positive electrode active material layer 101 as appropriate so that cracks and separation do not occur. Further, it is preferable that cracks and separation be made not to occur in the positive electrode active material layer 101 not only when the lithium-ion secondary battery is flat but also rolled into a cylinder shape, though it depends on forms of the lithium-ion secondary battery.

As the negative electrode current collector 105, a material having high conductivity such as copper, stainless steel, iron, or nickel can be used.

As the negative electrode active material layer 106, lithium, aluminum, graphite, silicon, germanium, or the like is used. The negative electrode active material layer 106 may be formed over the negative electrode current collector 105 by a coating method, a sputtering method, an evaporation method, or the like. Each material may be used alone as the negative electrode active material layer 106. The theoretical lithium occlusion capacity is larger in germanium, silicon, lithium, and aluminum than in graphite. When the occlusion capacity is large, charging and discharging can be performed sufficiently even in a small area and a function as a negative electrode can be obtained; therefore, cost reduction and miniaturization of the secondary battery can be realized. However, in the case of silicon or the like, the volume is increased approximately four times the volume before lithium occlusion; therefore, it is necessary to pay attention to the risk of explosion, the probability that the material itself gets vulnerable, and the like.

As the electrolyte, an electrolyte solution that is an electrolyte in a liquid state, a solid electrolyte that is an electrolyte in a solid state may be used. The electrolyte solution contains an alkali metal ion or an alkaline earth metal ion as a carrier ion, and this carrier ion is responsible for electric conduction. Examples of the alkali metal ion include a lithium ion, a sodium ion, and a potassium ion. Examples of the alkaline earth metal ion include a calcium ion, a strontium ion, and a barium ion. In addition, a beryllium ion and a magnesium ion can be used.

The electrolyte solution 111 includes, for example, a solvent and a lithium salt or a sodium salt dissolved in the solvent. Examples of the lithium salt include lithium chloride (LiCI), lithium fluoride (LiF), lithium perchlorate (LiClO₄), lithium tetrafluoroborate (LiBF₄), lithium hexafluoroarsenate (LiAsF₆), hexafluorophosphate (LiPF₆), and Li(C₂F₅SO₂)₂N. Examples of the sodium salt include sodium chloride (NaCl), sodium fluoride (NaF), sodium perchlorate (NaClO₄), and sodium fluoroborate (NaBF₄).

Examples of the solvent for the electrolyte solution 111 include cyclic carbonates (e.g., ethylene carbonate (hereinafter abbreviated to EC), propylene carbonate (PC), butylene carbonate (BC), and vinylene carbonate (VC)); acyclic carbonates (e.g., dimethyl carbonate (DMC), diethyl carbonate (DEC), ethylmethyl carbonate (EMC), methylpropyl carbonate (MPC), methylisobutyl carbonate (MIBC), and dipropyl carbonate (DPC)); aliphatic carboxylic acid esters (e.g., methyl formate, methyl acetate, methyl propionate, and ethyl propionate); acyclic ethers (e.g., y-lactones such as γ-butyrolactone, 1,2-dimethoxyethane (DME), 1,2-diethoxyethane (DEE), and ethoxymethoxy ethane (EME)); cyclic ethers (e.g., tetrahydrofuran and 2-methyltetrahydrofuran); cyclic sulfones (e.g., sulfolane); alkyl phosphate ester (e.g., dimethylsulfoxide, 1,3-dioxolane, trimethyl phosphate, triethyl phosphate, and trioctyl phosphate); and fluorides thereof. All of the above solvents can be used either alone or in combination for the electrolyte solution 111.

As the separator 110, paper; nonwoven fabric; glass fiber; synthetic fiber such as nylon (polyamide), vinylon (also called vinalon) (polyvinyl alcohol-based fiber), polyester, acrylic, polyolefin, or polyurethane; or the like may be used. Note that a material which is not dissolved in the electrolyte solution 111 described above should be selected.

Specific examples of the material for the separator 110 are high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane; derivatives thereof; cellulose; paper; and nonwoven fabric, all of which can be used either alone or in combination.

When charging of the lithium-ion secondary battery described above is performed, a positive electrode terminal is connected to the first electrode 121 and a negative electrode terminal is connected to the second electrode 122. An electron is taken away from the positive electrode 102 through the first electrode 121 and transferred to the negative electrode 107 through the second electrode 122. In addition, a lithium ion is eluted from the active material in the positive electrode active material layer 101 of the positive electrode, reaches the negative electrode 107 through the separator 110, and is taken into the active material in the negative electrode active material layer 106. The lithium ion and the electron are aggregated in this region and are occluded in the negative electrode active material layer 106. At the same time, in the positive electrode active material layer 101, an electron is released from the active material, and oxidation reaction of the metal M contained in the active material is caused.

At the time of discharging, in the negative electrode 107, the negative electrode active material layer 106 releases lithium as an ion, and an electron is transferred to the second electrode 122. The lithium ion passes through the separator 110, reaches the positive electrode active material layer 101, and is taken into the active material in the positive electrode active material layer 101. At that time, the electron from the negative electrode 107 also reaches the positive electrode 102, and reduction reaction of the metal M is caused.

The lithium-ion secondary battery which is manufactured as described above includes the lithium phosphate compound having an olivine structure or the lithium silicate compound having an olivine structure as the positive electrode active material. In addition, in the lithium phosphate compound or the lithium silicate compound, the second metal element which serves as a carrier generation source is added, so that the bulk electron conductivity is improved. Accordingly, in the lithium-ion secondary battery obtained in this embodiment, the discharge capacity can be large, and the charging and discharging rate can be high.

The structures, methods, and the like described in this embodiment can be combined as appropriate with any of the structures, methods, and the like described in other embodiments.

### Embodiment 3

In this embodiment, an application mode of a power storage device according to an embodiment of the present invention will be described.

The power storage device can be provided in a variety of electronic devices. For example, the power storage device can be provided in cameras such as digital cameras or video cameras, mobile phones, portable information terminals, e-book terminals, portable game machines, digital photo frames, audio reproducing devices, and the like. Moreover, the power storage device can be provided in electrically propelled vehicles such as electric vehicles, hybrid vehicles, electric railway cars, working vehicles, carts, wheelchairs, and bicycles.

The characteristics of the power storage device according to an embodiment of the present invention are improved; for example, larger discharge capacity and a higher charging and discharging rate are obtained. By improving the characteristics of the power storage device, the power storage device can also be compact and lightweight. When being provided with such a power storage device, electronic devices or electrically propelled vehicles can have a shorter charging time, a longer operating time, and reduced size and weight, and thus their convenience and design can be improved.

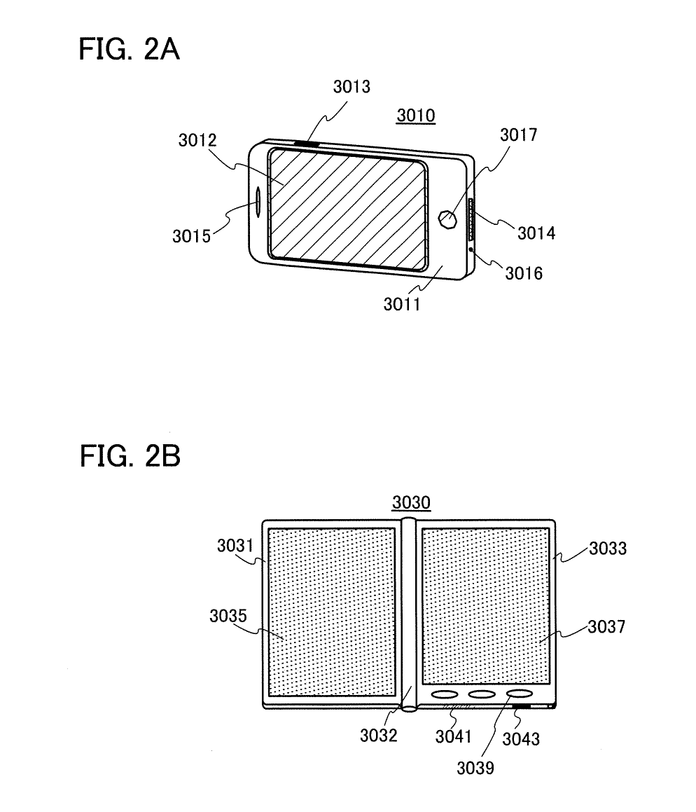

FIG. 2A illustrates an example of a mobile phone. In a mobile phone 3010, a display portion 3012 is incorporated in a housing 3011. The housing 3011 is provided with an operation button 3013, an operation button 3017, an external connection port 3014, a speaker 3015, a microphone 3016, and the like. When the power storage device according to an embodiment of the present invention is provided in such a mobile phone, the mobile phone can have improved convenience and design.

FIG. 2B illustrates an example of an e-book terminal. An e-book terminal 3030 includes two housings, a first housing 3031 and a second housing 3033, which are combined with each other with a hinge 3032. The first and second housings 3031 and 3033 can be opened and closed with the hinge 3032 as an axis. A first display portion 3035 and a second display portion 3037 are incorporated in the first housing 3031 and the second housing 3033, respectively. In addition, the second housing 3033 is provided with an operation button 3039, a power switch 3043, a speaker 3041, and the like. When the power storage device according to an embodiment of the present invention is provided in such an e-book terminal, the e-book terminal can have improved convenience and design.

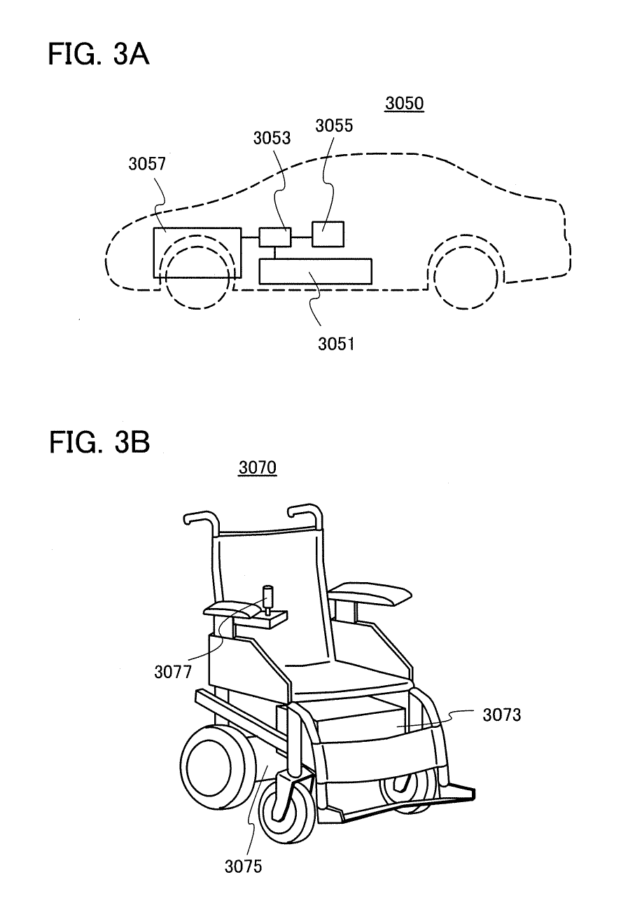

FIG. 3A illustrates an example of an electric vehicle. A power storage device 3051 is provided in an electric vehicle 3050. The power of the power storage device 3051 is controlled by a control circuit 3053 to be output and is supplied to a driving device 3057. The control circuit 3053 is controlled by a computer 3055.

The driving device 3057 includes a DC motor or an AC motor either alone or in combination with an internal-combustion engine. The computer 3055 outputs a control signal to the control circuit 3053 on the basis of input data such as data of operation (e.g., acceleration, deceleration, or stop) by a driver or data during driving (e.g., data on ascending or descending a slope, or data on a load on a driving wheel) of the electric vehicle 3050. The control circuit 3053 adjusts electric energy supplied from the power storage device 3051 in accordance with the control signal of the computer 3055 to control the output of the driving device 3057. In the case where the AC motor is mounted, an inverter which converts direct current into alternate current is also incorporated.

Charging of the power storage device 3051 can be performed by supplying power from the external by a plug-in technique. When the power storage device according to an embodiment of the present invention is provided as the power storage device 3051, a shorter charging time and improved convenience can be realized. Besides, the higher charging and discharging rate of the power storage device can contribute to greater acceleration and excellent performance of the electric vehicle. Further, when the power storage device 3051 can be reduced in size and weight as a result of improvement in its characteristics, the vehicle can be reduced in weight and the fuel-efficiency can be improved.

FIG. 3B illustrates an example of an electric wheelchair. A wheelchair 3070 includes a control portion 3073 which is provided with a power storage device, a power controller, a control means, and the like. The power of the power storage device is controlled by the control portion 3073 to be output and is supplied to a driving portion 3075. Further, the control portion 3073 is connected to a controller 3077. By operation of the controller 3077, the driving portion 3075 can be driven via the control portion 3073 and movement of the wheelchair 3070 such as moving forward/backward and a turn and speed can be controlled.

Charging of the power storage device of the wheelchair 3070 can also be performed by supplying power from the external by a plug-in technique. When the power storage device according to an embodiment of the present invention is provided as the power storage device 3051, a shorter charging time and improved convenience can be realized. Further, when the power storage device can be reduced in size and weight as a result of improvement in its characteristics, a user and a wheelchair helper can use the wheelchair 3070 more easily.

Note that in the case where the power storage device is provided in electric railway cars as electrically propelled vehicles, charging of the power storage device can be performed by supplying power from overhead wires or conductive rails.

The structures, methods, and the like described in this embodiment can be combined as appropriate with any of the structures, methods, and the like described in other embodiments.

### EXAMPLE

In this example, an example in which lithium manganese phosphate (LiMnPO₄) was manufactured as the material for an electrode by using the method according to an embodiment of the present invention will be described.

Lithium carbonate (LiCO₃), manganese (II) carbonate (MnCO₃), and ammonium dihydrogen phosphate (NH₄H₂PO₄) as materials of lithium manganese phosphate, and iron oxide (Fe₂O₃) were ground by ball mill treatment so as to be mixed. The ball mill treatment was performed in such a manner that acetone was used as a solvent and a ceramic ball (with a diameter φ of 3 mm) was used, and rotation was performed at 400 rpm for 2 hours.

Lithium carbonate is a material for introducing lithium, manganese (II) carbonate is a material for introducing manganese as the first metal element, and ammonium dihydrogen phosphate is a material for introducing a phosphate.

In this example, manganese (II) carbonate (MnCO₃) containing divalent manganese was used as the compound containing the first metal element, and iron oxide (Fe₂O₃) containing trivalent iron was added as the compound containing the second metal element. In addition, the ratio of the materials was adjusted so that the additive amount of iron (Fe³⁺) was set to 1 mol %, 2 mol %, 5 mol %, and 10 mol % of manganese (Mn²⁺), and a mixture material was formed under these four conditions. Table 1 shows specific weights of the materials.

TABLE 1

| | Material | | | |
|---|---|---|---|---|
| | Li₂CO₃ | Fe₂O₃ | MnCO₃ | NH₄H₂PO₄ |
| Mol % of Fe³⁺ | weight (g) | weight (g) | weight (g) | weight (g) |
| 1 mol % | 1.386 | 0.03 | 4.269 | 4.315 |
| 2 mol % | 1.388 | 0.06 | 4.231 | 4.321 |
| 5 mol % | 1.393 | 0.151 | 4.118 | 4.338 |
| 10 mol % | 1.403 | 0.303 | 3.927 | 4.367 |

After the ball mill treatment, the mixture material was shaped into pellets by applying a pressure of 150 kgf for 5 minutes with a pellet press machine.

Then, pellets of the mixture material were put in an alumina crucible and subjected to first baking (pre-baking) in a nitrogen atmosphere at a temperature of 350° C. for 10 hours.

After the first baking, the baked mixture material was ground in a mortar.

Then, glucose was weighed to 10 wt % with respect to the ground mixture material and added to the ground mixture material.

After addition of glucose, ball mill treatment was performed again. The ball mill treatment was performed in such a manner that acetone was used as a solvent and a ceramic ball (with a diameter φ of 3 mm) was used, and rotation was performed at 400 rpm for 2 hours.

After the ball mill treatment, the mixture material was shaped into pellets by applying a pressure of 150 kgf with a pellet press machine for 5 minutes again.

Then, pellets of the mixture material were put in an alumina crucible and subjected to second baking (main-baking) in a nitrogen atmosphere at a temperature of 600° C. for 10 hours.

After the second baking, the pellets were ground in a mortar, so that a material for an electrode of this example was manufactured.

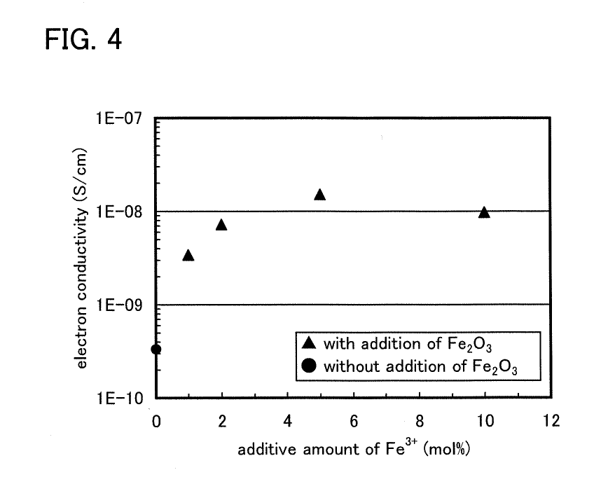

FIG. 4 shows the bulk electron conductivity of the material for an electrode which was manufactured. In FIG. 4, the horizontal axis indicates the additive amount of Fe³⁺ (mol %) with respect to Mn²⁺, and the vertical axis indicates the electron conductivity (S/cm). In FIG. 4, a black triangle denotes the electron conductivity of the mixture material which contains Fe₂O₃, and a black circle denotes the electron conductivity of a mixture material which does not contain Fe₂O₃ (that is, the additive amount of Fe³⁺ is 0 mol %) as a comparison material.

As shown in FIG. 4, it was confirmed that by adding Fe₂O₃ to the mixture material, the bulk electron conductivity was improved. This is probably because Fe³⁺ derived from Fe₂O₃ which was added served as an impurity with respect to Mn²⁺ in LiMnPO₄ and caused defects of Mn²⁺, and the defects generated carriers.

In addition, a conduction auxiliary agent and a binder were mixed into the lithium manganese phosphate as the material for an electrode. Acetylene black was used as the conduction auxiliary agent and polytetrafluoroethylene (PTFE) was used as the binder, and the mixture ratio (LiMnPO₄ :acetylene black:PTFT) in weight (wt %) was set to 80:15:5. The mixture material was formed into a pellet-shaped electrode by pressure extension with a roll press machine. After that, an active electrode current collector formed of aluminum was pressure-bonded to the electrode, whereby a positive electrode of a lithium-ion secondary battery was manufactured.

In addition, a lithium foil was used as a negative electrode and polypropylene (PP) was used as a separator in the lithium-ion secondary battery. In addition, an electrolyte solution in which a solute was lithium hexafluorophosphate (LiPF₆) and a solvent was ethylene carbonate (EC) and dimethyl carbonate (DC) was used. Note that the separator was impregnated with the electrolyte solution.

Through the above process, a coin-shaped lithium-ion secondary battery including the positive electrode, the negative electrode, the separator, and the electrolyte solution was obtained. Assembly of the positive electrode, the negative electrode, the separator, the electrolyte solution, and the like was performed in a glove box in an argon atmosphere.

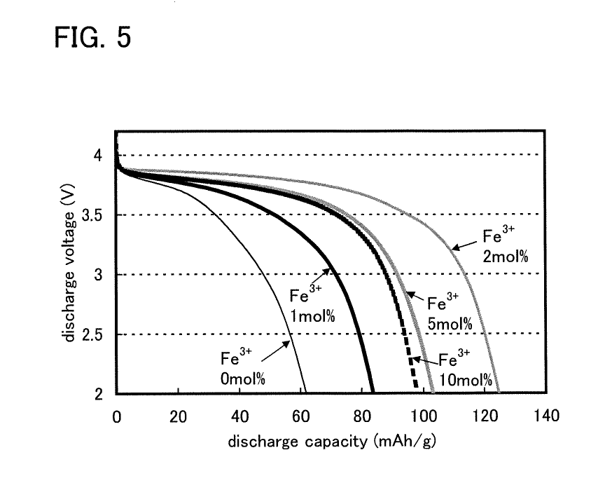

FIG. 5 shows discharge capacity of the obtained lithium-ion secondary battery. In FIG. 5, the horizontal axis indicates discharge capacity (mAh/g) and the vertical axis indicates discharge voltage (V).

From FIG. 5, it was confirmed that the discharge capacity of the lithium-ion secondary battery was improved when the material for an electrode obtained by adding Fe³⁺ to LiMnPO₄ was used as the positive electrode active material. This is probably because by addition of Fe³⁺, the bulk electron conductivity of the positive electrode active material was improved. In addition, it was confirmed that the discharge capacity was improved when the additive amount of Fe³⁺ was in the range of 1 mol % to 10 mol % inclusive with respect to Mn²⁺; in particular, a large effect was observed when the additive amount of Fe³⁺ was in the range of 2 mol % to 5 mol % inclusive with respect to Mn²⁺.

As described above, by adding a compound containing a metal element having a valence different from that of Mn²⁺ (that is, Fe₂O₃ containing Fe³⁺) to lithium manganese phosphate (LiMnPO₄), a material for an electrode with improved electron conductivity can be manufactured. In addition, when a lithium-ion secondary battery is formed with the use of the material for an electrode, a lithium-ion secondary battery with large discharge capacity can be obtained.

This application is based on Japanese Patent Application serial no. 2010-148970 filed with Japan Patent Office on Jun. 30, 2010, the entire contents of which are hereby incorporated by reference.

What is claimed is:

1. A method for manufacturing a power storage device, comprising the steps of:
mixing a compound containing lithium, a compound containing a first metal element selected from the group consisting of manganese, iron, cobalt, and nickel, a compound containing phosphorus, and a compound containing a second metal element having a valence different from that of the first metal element to form a mixture material; and
baking the mixture material to form a lithium phosphate compound containing the first metal element.

2. The method for manufacturing a power storage device according to claim 1, wherein the step of baking the mixture material comprises a first baking in which heat treatment is performed at a temperature of greater than or equal to 300° C. and less than or equal to 400° C. and a second baking in which heat treatment is performed at a temperature of greater than or equal to 500° C. and less than or equal to 800° C.

3. The method for manufacturing a power storage device according to claim 1, wherein the valence of the second metal element is 1 or 2 larger than that of the first metal element.

4. The method for manufacturing a power storage device according to claim 1, wherein the valence of the second metal element is 1 or 2 smaller than that of the first metal element.

5. The method for manufacturing a power storage device according to claim 1, wherein Fe₂O₃, Ti₂O₃, Cu₂O, or SiO₂ is used as the compound containing the second metal element.

6. The method for manufacturing a power storage device according to claim 1, wherein the mixture material comprises the second metal element at greater than or equal to 1 mol % and less than or equal to 10 mol % with respect to the first metal element.

7. The method for manufacturing a power storage device according to claim 1, further comprising the step of:
milling the mixture material by using balls with a diameter φ of greater than or equal to 1 mm and less than or equal to 10 mm before baking.

8. The method for manufacturing a power storage device according to claim 2, further comprising the steps of:
grinding the mixture material after the first baking;
milling the mixture material with addition of glucose after grinding; and
pressing the mixture material before the second baking.

9. The method for manufacturing a power storage device according to claim 1, wherein the lithium phosphate compound containing the first metal element is a positive electrode active material having an olivine structure.

10. A method for manufacturing a power storage device, comprising the steps of:
mixing a compound containing lithium, a compound containing a first metal element selected from the group consisting of manganese, iron, cobalt, and nickel, a compound containing silicon, and a compound containing a second metal element having a valence different from that of the first metal element to form a mixture material; and
baking the mixture material to form a lithium silicate compound containing the first metal element.

11. The method for manufacturing a power storage device according to claim 10, wherein the step of baking the mixture material comprises a first baking in which heat treatment is performed at a temperature of greater than or equal to 300° C. and less than or equal to 400° C. and a second baking in which heat treatment is performed at a temperature of greater than or equal to 500° C. and less than or equal to 800° C.

12. The method for manufacturing a power storage device according to claim 10, wherein the valence of the second metal element is 1 or 2 larger than that of the first metal element.

13. The method for manufacturing a power storage device according to claim 10, wherein the valence of the second metal element is 1 or 2 smaller than that of the first metal element.

14. The method for manufacturing a power storage device according to claim 10, wherein Fe₂O₃, Ti₂O₃, Cu₂O, or SiO₂ is used as the compound containing the second metal element.

15. The method for manufacturing a power storage device according to claim 10, wherein the mixture material comprises the second metal element at greater than or equal to 1 mol % and less than or equal to 10 mol % with respect to the first metal element.

16. The method for manufacturing a power storage device according to claim 10, further comprising the step of:
milling the mixture material by using balls with a diameter φ of greater than or equal to 1 mm and less than or equal to 10 mm before baking.

17. The method for manufacturing a power storage device according to claim 11, further comprising the steps of:
grinding the mixture material after the first baking;
milling the mixture material with addition of glucose after grinding; and
pressing the mixture material before the second baking.

18. The method for manufacturing a power storage device according to claim 10, wherein the lithium silicate compound containing the first metal element is a positive electrode active material having an olivine structure.
